(19) United States
(12) Patent Application Publication
(10) Pub. No.: US 2009/0024732 A1
(43) Pub. Date: Jan. 22, 2009

(54) APPARATUS FOR PREFIX CONTROL AND APPARATUS FOR PREFIX CHOICE

(75) Inventors: Jun Hirano, Kanagawa (JP); Chun Keong Benjamin Lim, Singapore (SG); Chan Wah Ng, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., Osaka (JP)

(21) Appl. No.: 12/281,435

(22) PCT Filed: Mar. 8, 2007
(86) PCT No.: PCT/JP2007/055150

§ 371 Date: Sep. 2, 2008

(30) Foreign Application Priority Data
Mar. 10, 2006 (JP) 2006-066708

(51) Int. Cl. G06F 15/173

(52) U.S. Cl. 709/223

(57) ABSTRACT

Disclosed is a technique which enables a communication node connected to a router made to advertise a plurality of prefixes to use an address including an appropriate prefix. According to this technique, an MR (Mobile Router) (10) multicasts, to a mobile PAN (31), a router advertisement message including a prefix (MNPNEMO) derived from a home network to which it pertains, a prefix (MNPAR) advertised from an AR (access router) (10a) and prefix choice information indicative of one of the prefixes to be selected on the basis of a function relative to the mobile PAN (31). A node (VN 20a, LN 20b) connected to the mobile PAN refers to the prefix choice information of the router advertisement message so as to select a prefix appropriate thereto for configuring its own global address.

### TECHNICAL FIELD

The present invention relates to an apparatus for prefix control and apparatus for prefix choice, which are designed to control a network prefix (sometimes referred to simply as a prefix) so that a node in a network configures an address correctly.

### BACKGROUND ART

The employment of the concept of the IP mobility enables a communication with a user even if the user is absent in his/her own house (goes out). As a typical example in which this IP mobility concept is achievable, there is a mobile IP defined in, for example, the following Non-Patent Document 1.

According to the mobile IP, even in the case of a disconnection of a wire cable in a mobile apparatus, this connection is shifted, for example, from a DSL (Digital Subscriber Line; wire connection) to a cellular access system (wireless connection), a user can continuously make a communication through the download of a file or a voice over IP (VoIP).

In addition, the user can establish a mobile personal area network (PAN) or the like to maintain the seamless connectivity with the network even if a movement takes place.

As a typical example for the realization of such an IP mobility, there is a network mobility (NEMO) defined in the Non-Patent Document 2. A user can accept that a foreign node (hereinafter referred to as a visitor node (VN) to conduct an operation in the user's mobile network.

A node in a mobile PAN sometimes carries out a stateless address auto-configuration in IPv6 (Internet Protocol version 6) as disclosed in the Non-Patent Document 3.

The node in the mobile PAN can receive a router advertisement (RA) including a prefix which is transmitted from a mobile router (MR). According to the IPv6 stateless address auto-configuration, the node can generate its own address by making a combination between information locally obtainable and information advertised from the router.

The router advertises a prefix for identifying a subnet associated with the link, and the host generates an “interface identifier” for uniquely identifying an interface in the subnet. In addition, a combination of these two information makes up an address.

On the other hand, in the case of the NEMO, an MR advertises its own mobile network prefix (MNP) with respect to a mobile PAN. The MNP advertised from the MR is one of two types of prefixes: a prefix (MNP_{AR} (or home prefix)) acquired from an access router AR) located in a foreign network or an MNP_{NEMO} disclosed in the Non-Patent Document 4.

In a case in which the MNP_{AR} is broadcasted to a lower-order network with respect to a VN, at a movement to a foreign network, the MR extracts an MNP_{AR} from an RA by an AR in a foreign network with which it establishes a connection, thereby acquiring the MNP_{AR} from the AR. At this time, the MR conducts an advertisement of MNP_{AR} so that the VN can configure a valid address within the mobile PAN.

On the other hand, the MR acquires an MNP_{NEMO} for a local node to which it pertains. The MNP_{NEMO} is previously allocated to a relevant MR (for example, allocated manually or automatically by a system which provides MNP_{NEMO}), or it is dynamically allocated thereto by a home agent (HA) of the MR through the use of a mechanism such as a prefix delegation of a DHCP (Dynamic Host Configuration Protocol) disclosed in the Non-Patent Document 5.

However, in a case in which an MNP is broadcasted to a mobile PAN to which an MR pertains, there is a possibility that a VN configures a valid address by use of MNP_{NEMO} and a local node (LN) configures a valid address through the use of MNP_{AR}. In this case, it becomes difficult for the MR to make a distinction as to whether a packet received by the MR is from the local node or from the VN.

The VN usually belongs to a home network different from the network to which the MR pertains, and in a case in which a global address is generated by use of the MNP_{NEMO} within the mobile PAN, a packet to be sent from a communication peer node, which exists outside the mobile PAN, to the VN passes not only through a home agent of the VN but also through a home agent of the MR. On the other hand, in a case in which the VN generates a global address in the mobile PAN by use of the MNP_{AR}, the above-mentioned packet arrives at the VN without passing through the home agent of the MR, which provides an advantage of reducing the redundant route.

In addition, the LN normally belongs to the same home agent to which the MR pertains, and in a case in which this global address is generated by use of the MNP_{AR} within the mobile PAN, there is a need to change this global address due to the movement of the MR, so the advantages of the NEMO becomes unobtainable. On the other hand, in a case in which the LN generates a global address by use of MNP_{NEMO} within the mobile PAN, there is no need for the LN to change the global address even in the case of the movement of the MR, so the advantages of the NEMO becomes obtainable.

In this description, for the above-mentioned reasons, the generation of a global address using an MNP_{NEMO} by a VN within a mobile PAN or the generation of a global address using an MNP_{AR} by an LN within a mobile PAN is sometimes expressed as a generation of an address using a mistaken (or inappropriate) prefix or as a mistaken (or inappropriate) generation of an address. Moreover, the generation of a global address using an MNP_{AR} by a VN within a mobile PAN or the generation of a global address using an MNP_{NEMO} by an LN within a mobile PAN is sometimes expressed as a generation of an address using a correct (or appropriate) prefix or as a correct (or appropriate) generation of an address.

On the other hand, the following Patent Document 1 proposes a method in which an MR prevents an advertisement of a network prefix (native network prefix corresponding to an MNP_{NEMO}) to be advertised intentionally. With the technique disclosed in this Patent Document 1, an MR acquires a delegated network prefix (corresponding to an MNP_{AR}) allocated by an AR and broadcasts this delegated network prefix to a mobile PAN to which it pertains. Thus, an MNP, the MR originally has, is not disclosed within the mobile PAN and, in consequence, a VN can prevent the address configuration through the use of the MNP the MR originally has.

In addition, the following Patent Document 2 proposes a method of maintaining the privacy and security on a prefix of an IP address in a mobile network. With the technique disclosed in this Patent Document 2, for a configuration of an address of a node within a mobile PAN, an MR transmits an RA specifying a null address prefix unreachable from a wide area network (WAN). Then, a node within the mobile PAN generates its own care-of address on the basis of the null address prefix.

A message to be transmitted from the node within the mobile PAN includes a destination address field describing a destination address reachable through a WAN and a source address field describing a care-of address of the node containing a null address prefix. Upon receipt of this message, with respect to this message, the MR changes the message by adding the care-of address of the node to a reverse routing header and inserting the care-of address of the MR describing an MNP into the source address field and then transmits it to an AR.
Non-Patent Document 1: D. Johnson, C. Perkins and J. Arkko, “Mobility Support in IPv6”, Internet Engineering Task Force Request For Comments 3775, June 2004.
Non-Patent Document 2: V. Devarapalli, R. Wakikawa, A. Petrescu and P. Thubert, “Network Mobility (NEMO) Basic Support Protocol”, Internet Engineering Task Force Request For Comments 3963, January 2005.
Non-Patent Document 3: S. Thomson and T. Narten, “IPv6 Stateless Address Autoconfiguration”, Internet Engineering Task Force Request For Comments 2462, December 1998.
Non-Patent Document 4: T. Kniveton and P. Thubert, “Mobile Network Prefix Delegation”, Internet Engineering Task Force Internet-Draft, August 2005.

Non-Patent Document 5: O. Troan and R. Droms, “IPv6 Prefix Options for Dynamic Host Configuration Protocol (DHCP) version 6”, Internet Engineering Task Force Request For Comments 3633, December 2003.
Patent Document 1: US Patent Application 2005/99971
Patent Document 2: US Patent Application 2004/248931

However, according to the technique disclosed in the Patent Document 1, since the MNP which the MR originally has is not advertised into the mobile PAN, a local node cannot acquire the MNP the MR originally has when performing the address auto-configuration mechanism. In consequence, the local node cannot carry out the address configuration or it cannot gain an advantage based upon the NEMO to be obtainable by carrying out the address configuration using a delegated network prefix allocated to the MR by an AR.

Meanwhile, according to the technique disclosed in the Patent Document 2, an MR is required to conduct the processing on changing with respect to all packets to be transmitted to a WAN, and a great deal of load is imposed on the processing in the MR. Moreover, there is a possibility of the interference with the operations of different protocols, for example, an IP security (IPsec) protocol and others, which can result in the cancellation of packets by the different protocols.

### DISCLOSURE OF THE INVENTION

For solving the above-mentioned problems, it is an object of the present invention to enable a communication node connected to a router, which advertises a plurality of prefixes, to use an address including an appropriate prefix. In particular, an object of the present invention is that, when connected to a mobile PAN of a mobile router which advertises a plurality of prefixes, a communication node can use an address including an appropriate prefix.

For achieving the above-mentioned purpose, in accordance with the present invention, there is provided an apparatus for prefix control, which is connected to a first network specified by a first prefix and which operates in a router having, as a subordinate, a second network specified by a second prefix, comprising:

prefix advertising means for advertising the first and second prefixes to the second network; and

prefix control means for allowing a communication node connected to the second network to use an address configured by the first or second prefix appropriate to the communication node.

This configuration enables a communication node connected to a router, which advertises a plurality of prefixes, to use an address including an appropriate prefix.

In addition to the above-mentioned arrangement, the apparatus for prefix control according to the present invention further comprises message generating means for generating, as a message for advertising the first and second prefixes, a message including the first and second prefixes and prefix choice information indicative of one of the first and second prefixes to be selected on the basis of a function of the communication node connected to the second network.

With this configuration, the router can offer an appropriate prefix to the communication node.

Combined with the above-mentioned configuration, the apparatus for prefix control according to the present invention is designed such that the first prefix is set at an appropriate prefix with respect to a communication node belonging to a home network different from a home network to which the router belongs, while the second prefix is set at an appropriate prefix with respect to a communication node belonging to the home network which is the home network to which the router belongs.

With this configuration, a visitor node (VN) can use an address including a prefix derived from a host network of the router while a local node (LN) can use an address including a prefix derived from a network under the router.

Moreover, combined with the above-mentioned configuration, the apparatus for prefix control according to the present invention comprises:

duplicate address detection message receiving means for receiving, from a communication node connected to the second network, a duplicate address detection message on the address of the communication node;

prefix judging means for making a judgment as to whether or not the address included in the message received by the duplicate address detection message receiving means is configured by using a prefixed appropriate to the communication node; and

response means for, when the judgment in the prefix judging means shows that the address is not configured by using the appropriate prefix, transmitting a message indicative of the fact that the address is in a duplicate state.

With the above-mentioned configuration, in a case in which the address including a prefix inappropriate to the communication node is set as the address of this communication node, it is possible to invalidate the use of this address.

Still moreover, combined with the above-mentioned configuration, the apparatus for prefix control according to the present invention comprises:

authentication means for carrying out authentication processing on a communication node connected to the second network; and

prefix appropriateness setting means for, with respect to a communication node which is not authenticated by the authentication means, setting the first prefix at a prefix appropriate to the communication node.

This configuration enables an unauthenticated communication node to be handled as a visitor node.

Yet moreover, combined with the above-mentioned configuration, the apparatus for prefix control according to the present invention comprises:

communication node identifying means for identifying the communication node connected to the second network whether or not the communication node belongs to the home network which is the home network to which the router belongs; and

address offering means for, on the basis of a result of the identification by the communication node identifying means, offering an address including the first prefix to a communication node belonging to a home network different from the home network to which the router belongs and offering an address including the second prefix to a communication node belonging to the home network which is the home network to which the router belongs.

This configuration enables an address including a prefix appropriate to the communication node to be allocated on the basis of a result of the identification on the communication node.

In addition, combined with the above-mentioned configuration, the apparatus for prefix control according to the present invention comprises:

packet receiving means for receiving, from a communication node connected to the second network, a packet in which an address configured by the communication node itself is set as a source address;

prefix judging means for making a judgment as to whether or not the address of the communication node set as the source address in the packet received by the packet receiving means is configured by using a prefix appropriate to the communication node; and

address offering means for, when the judgment in the prefix judging means shows that the address is not configured by using the appropriate prefix, offering an address including the appropriate prefix.

With the above-mentioned configuration, a router can refer to a packet transmitted from a communication node to inspect an address the communication node configures through the use of a stateless address auto-configuration mechanism and, in the case of the use of the appropriate prefix, it can offer an address including an appropriate prefix to this communication node.

Still additionally, combined with the above-mentioned configuration, the apparatus for prefix control according to the present invention comprises:

packet receiving means for receiving, from a communication node connected to the second network, a packet in which an address configured by the communication node itself is set as a source address;

prefix judging means for making a judgment as to whether or not the address of the communication node set as the source address in the packet received by the packet receiving means is configured by using a prefix appropriate to the communication node; and

response means for, when the judgment in the prefix judging means shows that the address is not configured by using the appropriate prefix, transmitting a message indicative of the fact that the address is in a duplicate state.

With the above-mentioned configuration, a router can refer to a packet transmitted from a communication node to inspect an address the communication node configures through the use of a stateless address auto-configuration mechanism and, in the case of the use of the inappropriate prefix, it can invalidate the use of the address of this communication node.

Yet additionally, combined with the above-mentioned configuration, the apparatus for prefix control according to the present invention comprises:

packet receiving means for receiving, from a communication node connected to the second network, a packet in which an address configured by the communication node itself is set as a source address;

prefix judging means for making a judgment as to whether or not the address of the communication node set as the source address in the packet received by the packet receiving means is configured by using a prefix appropriate to the communication node; and

appropriate prefix advertising means for, when the judgment in the prefix judging means shows that the address is configured by using an inappropriate prefix, advertising a prefix, appropriate to the communication node, to the communication node.

With the above-mentioned configuration, a route can refer to a packet transmitted from a communication node to inspect an address the communication node configures through the use of a stateless address auto-configuration mechanism and, in the case of the use of the inappropriate prefix, it can offer an appropriate prefix to this communication node.

Moreover, combined with the above-mentioned configuration, in the apparatus for prefix control according to the present invention, the router is a movable mobile router or an access router fixed to a network.

With this configuration, in a case in which a mobile router or access router permits the use of two or more different types of prefixes in a network under it, it becomes clear that the present invention is applicable.

Furthermore, for achieving the above-mentioned purpose, in accordance with the present invention, there is provided an apparatus for prefix choice, which operates in a communication node connectable to a network, comprising:

message receiving means for receiving, from a router connected to a first network specified by a first prefix and having, as a subordinate, a second network specified by a second prefix, a message including the first and second prefixes and prefix choice information indicative of one of the first and second prefixes to be selected on the basis of a function of a communication node connected to the second network; and

prefix choosing means for, on the basis of the prefix choice information included in the message received by the message receiving means, choosing the first or second prefix appropriate to the communication node, which is to be used at a configuration of an address of the communication node.

With this configuration, a communication node connected to a router which advertises a plurality of prefixes can use an address including an appropriate prefix.

Combined with the above-mentioned configuration, in the apparatus for prefix choice according to the present invention, in a case in which the communication node belongs to a home network different from a home network to which the router belongs, the communication node chooses the first prefix as an appropriate prefix while, when the communication node belongs to a home network which is a home network to which the router belongs, the communication node chooses the second prefix as an appropriate prefix.

With this configuration, a visitor node (VN) can use an address including a prefix derived from a host network of a router and a local node (LN) can use an address including a prefix stemming from a network under the router.

The present invention has the above-described configurations, so a communication node connected to a router which advertises a plurality of prefixes can use an address including an appropriate prefix. In particular, according to the present invention, when a communication node is connected to a mobile PAN of a mobile router which notifies a plurality of prefixes, an address including an appropriate prefix becomes available.

### BRIEF DESCRIPTION OF THE DRAWINGS

FIG. 1 is a block diagram showing one example of a preferred configuration of a mobile router according to an embodiment of the present invention;

FIG. 2 is a block diagram showing one example of a preferred configuration of a node according to an embodiment of the present invention;

FIG. 3 is a block diagram showing one example of a preferred system according to an embodiment of the present invention;

FIG. 4 is an illustration of one example of a router advertisement message to be transmitted from a mobile router according to an embodiment of the present invention;

FIG. 5 is a sequence chart showing one example of a method in which a mobile router offers a prefix for a stateless address configuration to a node, according to a first embodiment of the present invention;

FIG. 6 is a flow chart showing one example of a method in which a mobile router offers a prefix for a stateless address configuration to a legacy node, according to a second embodiment of the present invention;

FIG. 7 is a flow chart showing one example of a method in which a mobile router offers a prefix for a stateless address configuration to an unauthenticated local node, according to a third embodiment of the present invention;

FIG. 8 is a sequence chart showing one example of a method of offering a prefix to a legacy node, which carries out a duplicate address detection on only its own interface address (interface identifier), according to a fifth embodiment of the present invention;

FIG. 9 is a sequence chart showing one example of a method of carrying out a stateful address configuration with respect to a legacy node, which conducts a duplicate address detection on only its own interface address (interface identifier), according to a sixth embodiment of the present invention; and

FIG. 10 is a sequence chart showing one example of a method of offering a prefix for a stateless address configuration to a legacy node, which conducts a duplicate address detection on only its own interface address (interface identifier), according to a seventh embodiment of the present invention.

### BEST MODE FOR CARRYING OUT THE INVENTION

A description will be given hereinbelow of embodiment of the present invention. First of all, the definition of terms will be made hereinbelow for a better understanding of the present invention.

A “mobile personal area network (mobile PAN)” signifies a personal network a node establishes on the basis of security-related information produced directly or indirectly.

A “mobile network prefix (MNP)” signifies an IPv6 prefix delegated to a mobile router and advertised in a mobile PAN. In the mobile PAN, the advertisement of one or more mobile network prefixes is feasible. For example, the MNP contains an MNP_{AR} depending on an AR (advertised from an AR) with which a mobile router establishes a connection and an MNP_{NEMO} a mobile router has originally (allocated by a home agent of a mobile router).

A “router advertisement (RA)” depicts a packet to be transmitted from a router periodically or as a response to a router solicitation message. The router advertisement is a packet for advertising the presence (address) of a router and contains various link parameters and internet parameters. Moreover, the router advertisement includes prefixes to be used for a judgment on whether existing on the same link (on-link determination) and/or an address configuration, recommended hop limit values, and others.

In the following description, specified numeric values, times, protocol names and other parameters are set for a sufficient understanding of the present invention. However, it is clear that a person skilled in the art can carry out the present invention irrespective of these specified detailed definitions. Moreover, for avoiding the present invention from being unclear more than necessary, well-known components and modules are illustrated in block diagrams.

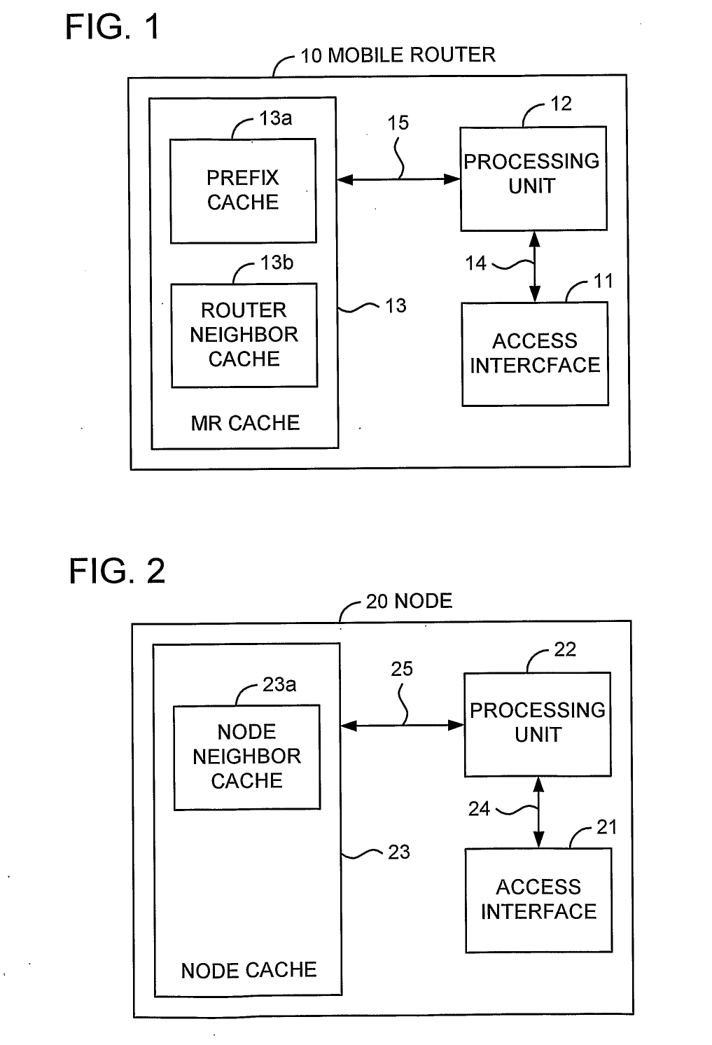

First, referring to FIG. 1, a description will be given hereinbelow of a preferred configuration of a mobile router (MR) according to an embodiment of the present invention. FIG. 1 is a block diagram showing one example of a preferred configuration of a mobile router according to an embodiment of the present invention.

In the configuration example shown in FIG. 1, an MR 10 has an access interface 11. The MR 10 enables the transmission/reception of a packet through the access interface 11 to/from different nodes or routers with which the MR 10 makes a communication. As one example of the access interface 11, there are Wi-Fi, Bluetooth (registered trademark), cellular, but it is not limited to these. Moreover, as one example of a packet to be transmitted from the access interface 11, there is a router advertisement, but it is not limited to this. Still moreover, the access interface 11 carries out the transmission/reception of a packet through a path 14 to/from a processing unit 12.

In addition, the MR 10 has the processing unit 12 designed to conduct the processing on a transmission/reception packet. The processing unit 12 has a function to generate a router advertisement (RA) including a prefix and information whereby a node connected to the MR 10 can choose a prefix. The prefix included in the router advertisement contains a mobile network prefix (MNP_{AR}) of an access router and a mobile network prefix (MNP_{NEMO}) of a network mobility, but it is not limited to these information.

Still additionally, it is preferable that, as specified in the Non-Patent Document 3, the processing unit 12 has a function to generate a neighbor advertisement message at the duplicate address detection. Yet additionally, it is preferable that the processing unit 12 has a function to process authentication information related to a node connected to the MR 10. As one example of an authentication method to be conducted by a node, there is an 802.1x authentication method, but it is not limited to this. Although it is preferable that the authentication information includes node identification information, digital certificates, tokens and others, it is not limited to these information.

Furthermore, it is also acceptable that the processing unit 12 has a function to make a judgment as to whether or not a prefix to be used for a global address by a node connected to the MR 10 is correct to this node. Still furthermore, the processing unit 12 has a function to, in a case in which a node uses a mistaken prefix, make a response through the use of a neighbor advertisement (NA) or a router advertisement (RA).

The MR 10 includes an MR cache 13 for storing information needed for the MR 10. As an example of the information to be stored in the MR cache 13, there are authentication information on a node connected to the MR 10, a prefix cache 13a and a router neighbor cache 13b, but it is not limited to these.

The prefix cache 13a stores an MNP_{NEMO} and an MNP_{AR}. The router neighbor cache 13b stores a set of entries on neighbor nodes to which traffic has been communicated recently. The information to be stored in the prefix cache 13a or the router neighbor cache 13b is not limited to the above-mentioned information.

Secondly, referring to FIG. 2, a description will be given of a preferred configuration of a node (node connected to a mobile PAN) according to an embodiment of the present invention. FIG. 2 is a block diagram showing one example of a preferred configuration of a node according to an embodiment of the present invention.

In the configuration example shown in FIG. 2, a node 20 includes an access interface 21. The node 20 can carry out the transmission/reception of a packet through the access interface 21 to/from other nodes or routers. As one example of the access interface 21, there are Wi-Fi, Bluetooth (registered trademark), cellular and others, but it is not limited to these. Moreover, as one example of a packet to be transmitted from the access interface 21, there is a neighbor solicitation, but it is not limited to this. Still moreover, the access interface 21 carries out the transmission/reception of a packet through a path 24 with respect to a processing unit 22.

In addition, the node 20 includes the processing unit 22 which is made to conduct the processing on a transmission/reception packet. The processing unit 22 has a function to generate a valid address of the node 20. The processing unit 22 configures an address by making a combination between a mobile network prefix (MNP) extracted from an RA and an interface identifier it has produced. Moreover, the processing unit 22 has a function to generate a neighbor solicitation message at the duplicate address detection.

Still additionally, the node 20 includes a node cache 23 for storing information needed for a node. As one example of the information to be stored in the node cache 23, there are personal authentication information on the node 20, a node neighbor cache 23a and others, but it is not limited to these. The node neighbor cache 23a stores a set of entries on neighbor nodes to which traffic has been sent recently. The information to be stored in the node neighbor cache 23a is not limited to the above-mentioned information.

Although in this description a case in which the node 20 (VN 20a and LN 20b) principally serves as a host is described as one example, it is also acceptable that the node 20 is a router having a network as a subordinate. That is, for example, the node 20 can be a mobile router containing an NEMO protocol.

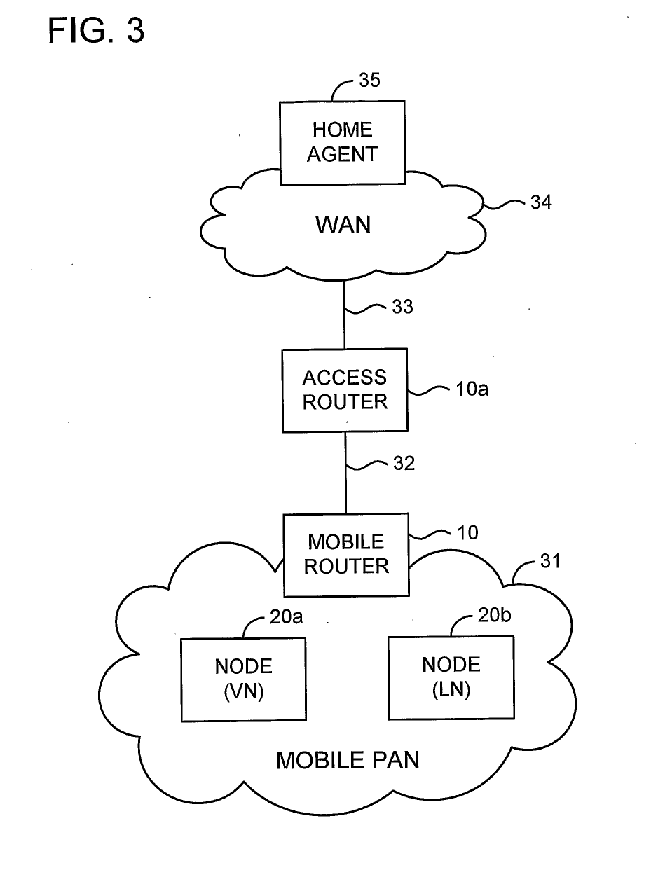

Furthermore, referring to FIG. 3, a description will be given hereinbelow of a preferred system according to an embodiment of the present invention. FIG. 3 is an illustration of one example of a preferred system according to an embodiment of the present invention. In the system shown in FIG. 3, a visitor node (VN) 20a is connectable to a mobile personal area network (mobile PAN) 31. For example, the VN 20a is a node which is not possessed by the user of the mobile PAN 31. Moreover, a local node (LN) 20b is connectable to the mobile PAN 31. For example, the LN 20b is a node possessed by the user of the mobile PAN 31.

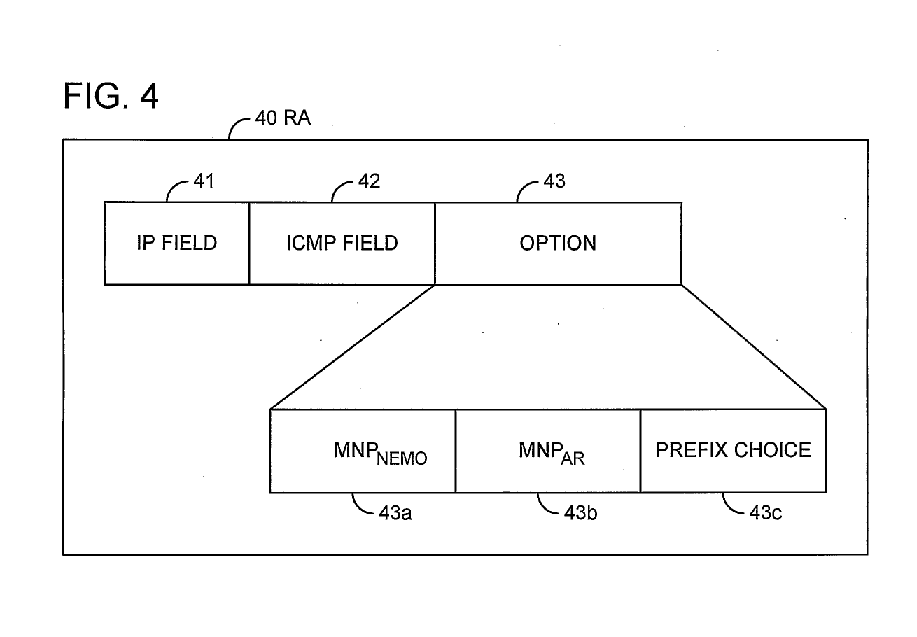

In addition, the mobile PAN 31 has an MR 10. The MR 10 is a router which is capable of changing a network connection point by moving from one link to a different link. Preferably, the MR 10 has a function to transfer a packet among two or more interfaces and to transmit a router advertisement into the mobile PAN 31. Preferably, for example, as shown in FIG. 4 described later, the router advertisement to be transmitted from the MR 10 contains an MNP_{NEMO}, an MNP_{AR} and information for the choice of a prefix. However, it is not limited to this.

Still additionally, preferably, the VN 20a and the VN 20b are authenticated by the MR 10 according to an authentication technology. As one example of the aforesaid authentication technology, for instance, there is 802.1x or the like, but it is not limited to this. Thus, the VN 20a and the VN 20b are authorized to operate within the mobile PAN 31.

Yet additionally, in the system shown in FIG. 3, an access router (AR) 10a exists on an edge of an access network (not shown) and is connected through a path 33 to a wide area network (WAN) 34, and the MR 10 is connected through a path 32 to the AR 10a. This configuration provides the connectivity of an internet protocol (IP), and the AR 10a functions as a default router for the MR 10. Moreover, owing to this configuration, the MR 10 can function as a gateway between the mobile PAN 31 and the WAN 34.

Furthermore, in the system shown in FIG. 3, a home agent (HA) 35 is a home router for the MR 10, which performs the allocation and registration of the MNP_{NEMO} to the MR 10.

Preferably, the VN 20a and the VN 20b are realized as a mobile node or a fixed node. As some examples of the VN 20a and the VN 20b, there are printers, personal computers, other electronic peripherals and others, but they are not limited to these. Moreover; it is also acceptable that one or a plurality of nodes 20 are connected to the mobile PAN 31. Still moreover, a person skilled in the art would appreciate that one or more routers can be connected to the mobile PAN 31 (it is also acceptable that the user of the mobile PAN 31 possesses these routers, but the user thereof does not necessarily possess them). The routers are also realizable as a mobile router or a fixed router.

Still furthermore, the MR 10 and the HA 35 can establish a secure association for the mutual communication therebetween through the use of a security technology. As one example of the aforesaid security technology, there is an internet key exchange (IKE), but it is not limited to this.

In the system shown in FIG. 3, when the MR 10 is connected to a foreign link, the MR 10 receives a router advertisement (RA) including an MNP_{AR} from the AR 10a. At this time, the MR 10 configures a valid care-of address by use of MNP_{AR}, and stores it in the MR cache 13a. Moreover, the MR 10 establishes a security association with the HA 35. When the security association is established between the MR 10 and the HA 35, the MR 10 conducts the processing to transmit a binding update (BU) message to the HA 35, thereby updating the address (valid care-of address configured using MNP_{AR}) at the current connection point.

The HA 35 checks whether or not the BU message is from a valid home user and, when it is from the valid home user, updates it sown BU cache. At this time, the HA 35 associates a unique home address of the MR 10 with the current care-of address of the MR 10.

Moreover, the MR 10 issues a request for an MNP to the HA 35, and it is statically allocated from the HA 35 according to, for example, a technique such as a DHCPv6 prefix delegation. Incidentally, the technique for the allocation of the MNP is not limited to the DHCPv6 prefix delegation. Still moreover, the HA 35 transmits an RA including MNP_{NEMO} to the MR 10. Thus, the HA 35 can manage the MNP used by the MR 10.

As a different mode, it is also possible that the MR 10 generates the MNP_{NEMO}, and advertises the MNP_{NEMO} to a node or router within the mobile PAN 31 and registers it in the HA 35. Thus, the MR 10 can dynamically generate the MNP_{NEMO}, thereby reducing the processing dependency on the HA 35 (processing load of the HA 35). For example, in a case in which the MR 10 acquires a valid MNP_{NEMO} according to the above-mentioned method, the MR 10 stores this MNP_{NEMO} in the prefix cache 13a.

After acquiring the needed prefixes (above-mentioned MNP_{AR} and MNP_{NEMO}), the MR 10 constructs a router advertisement (for example, a router advertisement shown in FIG. 4) including these prefixes and then notifies it into the mobile PAN 31.

FIG. 4 is an illustration of one example of a router advertisement message to be transmitted from a mobile router according to an embodiment of the present invention.

In FIG. 4, an RA 40 depicts a router advertisement to be generated by the MR 10. The RA 40 has an IP field 41. An IP header of the RA 40 is set in the IP field 41. Moreover, in the IP field 41, for example, there are included a source address of an interface of the MR 10, a multicast destination address and others, but not limited to these.

In addition, the RA 40 can has an internet control message protocol (ICMP) field 42 which is to be used for carrying out an internet-layer function. It is also acceptable that an address configuration flag, a router lifetime and others are included in the ICMP field 42, but not limited to these.

Still additionally, the RA 40 has an option 43. This option 43 contains prefix information to be used by the VN 20a or the LN 20b for the address configuration. The option 43 also can contain information such as an MNP_{NEMO} 43a, an MNP_{AR} 43b and a prefix choice 43c, but not limited to these.

The MNP_{NEMO} 43a contains a prefix (MNP_{NEMO}) to be used by a local node (LN) within the mobile PAN 31 for the address configuration. On the other hand, the MNP_{AR} 43b contains a prefix (MNP_{AR}) to be used by a visitor node (VN) within the mobile PAN 31 for the address configuration. Although in the illustration one prefix is included in each of the MNP_{NEMO} 43a and the MNP_{AR} 43b, a person skilled in the art would appreciate that it is also acceptable that a plurality of prefixes are included in each of the MNP_{NEMO} 43a and the MNP_{AR} 43b.

Still additionally, through the prefix choice 43c, an advertisement on a prefix to be used for the address configuration based on a function (for example, whether or not a home network of a node is the same as a home network of the MR 10) within the mobile PAN 31 is made to a node within the mobile PAN 31. In a case in which the MR 10 advertises one or more prefixes into the mobile PAN 31, it is preferable that the MR 10 adds information, which indicates how a node within the mobile PAN 31 uses a prefix, to the prefix choice 43a.

Concretely, the prefix choice 43c contains identification information showing which of two types of information included in an RA to be multicasted indicates an MNP_{NEMO} or an MNP_{AR}. Thus, a VN or LN capable of reading out the information from the prefix choice 43c can choose an appropriate prefix for its own communication (the VN chooses the MNP_{AR} while the LN selects the MNP_{NEMO}).

In a case in which a node receives the RA 40 including one or more prefixes, this node can process the information stored in the prefix choice 43a so as to specify which of the prefixes is to be used for configuring its own global address.

In FIG. 4, in the option 43 existing in one RA 40, there are included the fields storing two types of prefixes of the MNP_{NEMO} 43a and the MNP_{AR} 43b and there is further provided the prefix choice 43 storing the information indicative of the type to which each of the prefixes within the option 43 belongs. However, the RA 40 shown in FIG. 4 is one example, and a different message format is also employable.

In this connection, although two types of prefixes are simultaneously inserted into the RA 40 shown in FIG. 4, more (three or more) prefixes can also be inserted into an RA. Moreover, although two types of prefixes are simultaneously inserted into the RA 40 shown in FIG. 4, it is also acceptable that, for example, the two types of prefixes of the MNP_{NEMO} 43a and the MNP_{AR}43b are transmitted by different RAs. Still moreover, although in the RA 40 shown in FIG. 4 the prefix choice 43c is located after the disposition of the two types of prefixes, it is also acceptable that, for example, information (for instance, a flag) indicating which of the types applies to a prefix included in the following field is inserted into a leading portion of the field of each of the types of prefixes of the MNP_{NEMO} 43a and the MNP_{AR} 43b. Still moreover, in a case in which the prefix disposition within the RA 40 is determined in advance, for example, when a prefix is inserted by one into the RA 40 in the order of the MNP_{NEMO} 43a and the MNP_{AR} 43b, the field for the prefix choice 43 becomes unnecessary.

Operations according to first to eighth embodiments of the present invention will be described hereinbelow with reference to the configuration of the MR 10 shown in FIG. 1, the configuration of the node 20 shown in FIG. 2, the network configuration shown in FIG. 3 and the RA message format shown in FIG. 4.

### FIRST EMBODIMENT

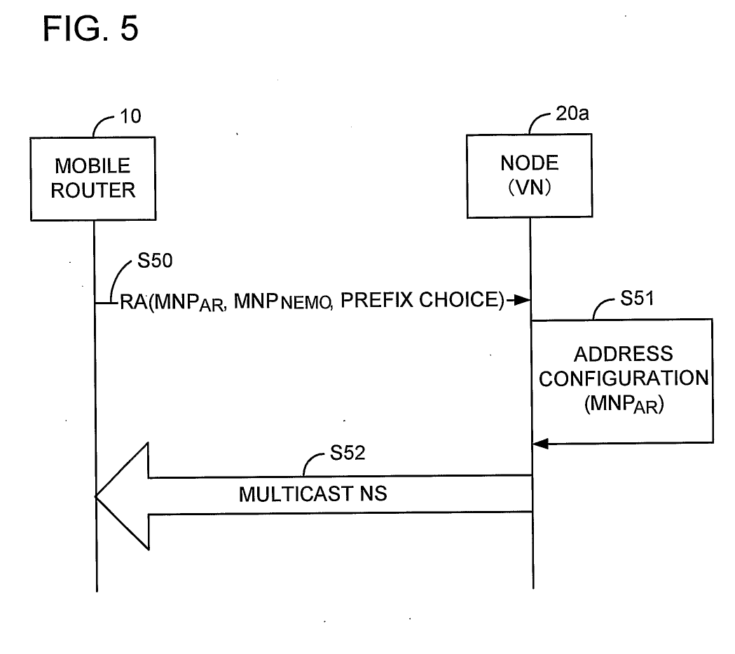

First of all, referring to FIG. 5, a description will be given hereinbelow of a method in which a mobile router offers a prefix for a stateless address configuration to a node. FIG. 5 is a sequence chart showing one example of a method, in which a mobile router provides a stateless address configuration prefix to anode, according to a first embodiment of the present invention.

In FIG. 5, it is preferable that a VN 20a has moved to a mobile PAN 31 and the VN 20a has already been authenticated by an MR 10 by using, for example, an authentication technique such as 801.x (but not limited to 801.x).

At a step S50, the MR 10 multicasts an RA 40 into the mobile PAN 31. After acquiring the RA 40, at a step S51, the VN 20a can carry out an address configuration. For the address configuration at the step S51, the VN 20a can extract an MNP_{AR} 43b from the RA 40 on the basis of the information in the RA prefix choice 43c and combine an interface identifier, it produced, with the MNP_{AR} 43b so as to create a valid tentative address (address candidate the VN 20a uses as a global address).

After creating the tentative address, the VN 20a multicasts a neighbor solicitation (NS) to the mobile PAN 31 at a step S52 in order to make a judgment as to whether or not this tentative address is unique within the mobile PAN 31. The NS transmitted at the step S52 contains, for example, an unspecified source address and a tentative address of the VN 20a, but not limited to this.

Upon receipt of the NS of the VN 20a transmitted at the step S52, for example, on the basis of the source address, a node or a router within the mobile PAN 31 can make a judgment on the type of solicitation message corresponding to this NS. Since the NS message transmitted at the step S52 has an unspecified source address, the node or router within the mobile PAN 31 judges that this NS was transmitted from a node which carries out the duplicate address detection (DAD).

In a case in which a different node or router within the mobile PAN 31 is using a tentative address described in this NS, the tentative address is regarded as being in a duplicate condition and, in response to the NS, the specified node or router multicasts a neighbor advertisement (NA) into the mobile PAN 31.

In a case in which the VN 20a does not receive a valid NA (that is, an NA indicative of the address duplication state) with respect to the NS transmitted at the step S52, the tentative address is considered as being unique, and the tentative address is used as a global address of the VN 20a within the mobile PAN 31.

However, in a case in which the VN 20a has received a valid NA with respect to the NS transmitted at the step S52, the tentative address is not unique within the mobile PAN 31 (that is, for example, this tentative address has already been used by a different node). In this case, the VN 20a updates a node neighbor cache 23a on the basis of this tentative address. Moreover, the VN 20a generates a new tentative address and multicasts a new NS into the mobile PAN 31 (it carries out a duplicate address detection on a new tentative address).

As described above, according to the first embodiment of the present invention, a node or a router within the mobile PAN 31 can select a correct MNP from the RA 40 and configure its own address through the use of a stateless mechanism. Therefore, the MR 10 can realize the prefix allocation control to the node or router within the mobile PAN 31.

### SECOND EMBODIMENT

Furthermore, a second embodiment of the present invention will be described hereinbelow. In the case of the sequence chart shown in FIG. 5, the VN 20a is required to be capable of understanding the information stored in the prefix choice 43c to determine one MNP to be used within the RA 40. A description will be given hereinbelow of a method, whereby a legacy node can carry out the above-described address configuration method, in the second embodiment of the present invention. In the following description of the second embodiment of the present invention, let it be assumed that the VN 20a shown in FIG. 5 is a legacy node. The legacy node is a node based on a conventional technique, and it cannot understand, for example, the information stored in the prefix choice of the RA 40 shown in FIG. 4 and cannot actively conduct the choice of an appropriate prefix.

In the second embodiment of the present invention, since, even if receiving the RA 40 at the step S50, the VN 20a cannot grasp the information within the prefix choice 43c, for example, it chooses an available prefix existing at the head of the option 43 in the RA 40. In the example described here, let it be assumed that the VN 20a selects the MNP_{NEMO} 43a and carries out the address configuration at the step S51 to generate a tentative address. This processing is the same as the processing described above with reference to FIG. 5, and the detailed description thereof will be omitted. Moreover, upon the generation of a tentative address, the VN 20a multicasts a neighbor solicitation (NS) into the mobile PAN 31. This processing is also the same as the processing described above with reference to FIG. 5, and the detailed description thereof will be omitted.

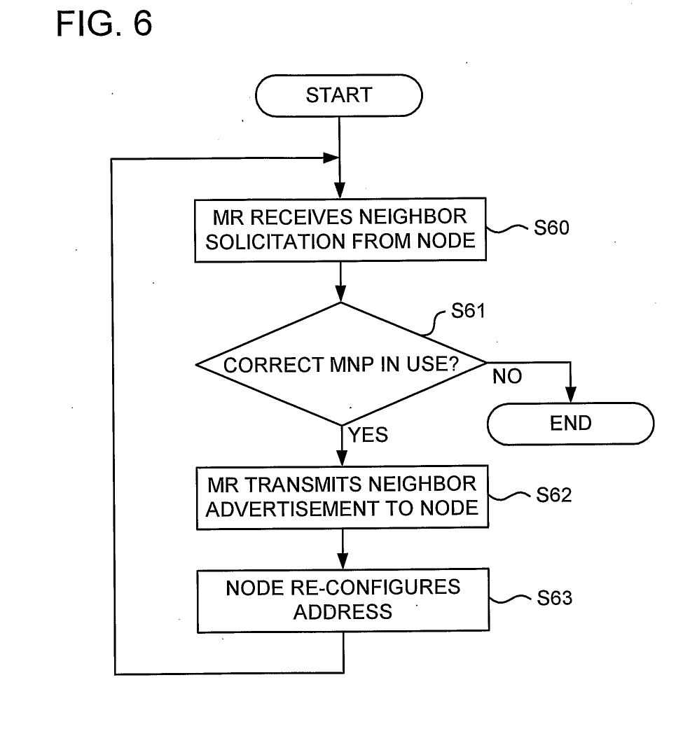

Secondly, with reference to FIG. 6, a description will be given hereinbelow of a method, in which a mobile router offers a prefix for a stateless address configuration to a legacy node, according to the second embodiment of the present invention. FIG. 6 is a flow chart showing one example of a method, in which a mobile router a stateless address configuration prefix to a legacy node, according to the second embodiment of the present invention. The processing in steps S60 to S62 of the flowchart shown in FIG. 6 are to be implemented by the MR 10, while the processing in a step S63 is to be conducted by the VN 20a (legacy node).

At the step S60, the MR 10 receives an NS transmitted from the VN 20a at the step S52, and at a step S61, the MR 10 checks the tentative address so as to confirm whether or not the VN 20a is using a correct MNP.

The MR 10 can make a judgment as to whether the MNP used by the VN 20a is correct (i.e., MNP_{AR}) or incorrect (i.e., MNP_{NEMO}). If the MR 10 makes a judgment that the VN 20a is using a correct MNP, the operation comes to an end without carrying out special processing.

On the other hand, when making a judgment that the VN 20a is using a mistaken MNP, at the step S62, the MR 10 multicasts an NA in response to the NS from the VN 20a which was transmitted at the step S52. This NA indicates an address duplication condition in DAD. That is, the MR 10 is designed to make a response with an NA indicative of the address duplication in the DAD with respect to the tentative address using the mistaken MNP.

Upon receipt of a valid NA (i.e., an NA indicative of the address duplication), the VN 20a makes a judgment that this tentative address is not unique within the mobile PAN 31, and updates the node neighbor cache 23a on the basis of this address. In this case, at the step S63, the VN 20a generates a new tentative address and multicasts a new NS into the mobile PAN 31.

In addition, in a case in which the DAD processing on the tentative address configured using an MNP comes out to be a failure and, for example, if the number of times of failure of the DAD processing on the tentative address including a specified MNP (i.e., MNP_{NEMO}) reaches a predetermined value, the VN 20a employs a different MNP (i.e., MNP_{AR}) in the RA 40. Thus, the VN 20a can configure an address including an appropriate prefix (MNP_{AR}).

As described above, according to the second embodiment of the present invention, the MR 10 can configure a new address by multicasting an NA indicative of an address duplication in response to an NS of the VN 20a including a tentative address configured using a mistaken MNP (MNP_{NEMO}). In this situation, in a case in which a legacy node or a legacy router selects a different correct MNP (MNP_{AR}), it can configure a valid address usable within the mobile PAN 31. Thus, the legacy node or legacy router also becomes operable in the present invention, and the advantages similar to those of the above-described first embodiment of the present invention are obtainable.

A person skilled in the art would appreciate that the second embodiment of the present invention accepts the presence of a plurality of legacy routers or legacy nodes within the mobile PAN 31.

### THIRD EMBODIMENT

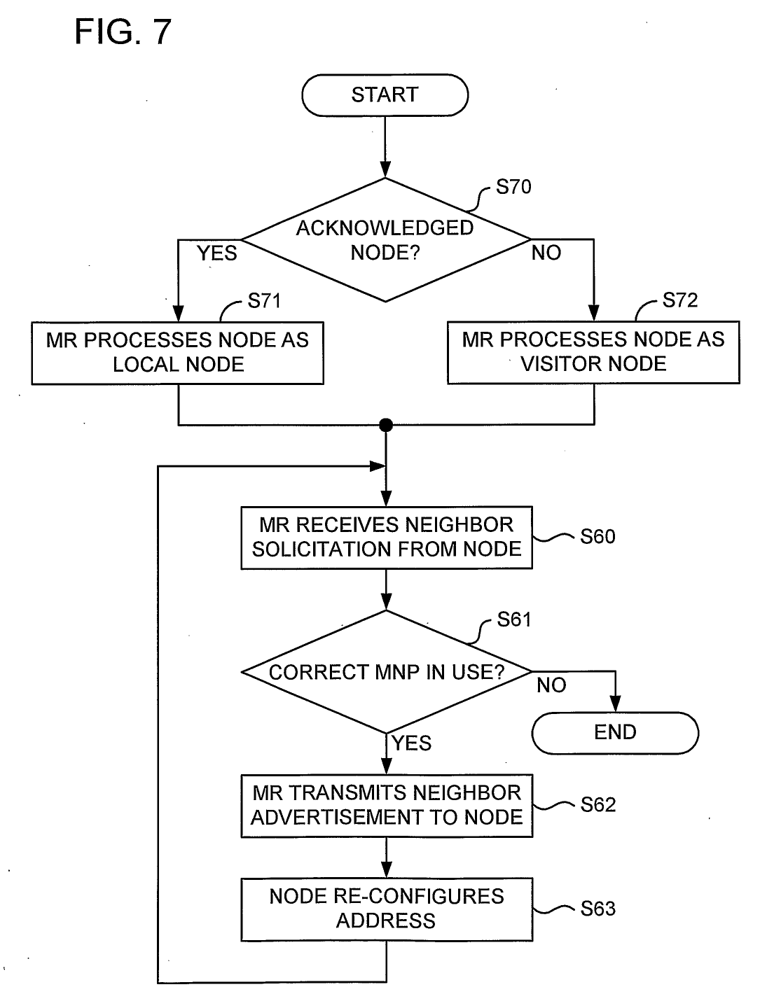

Furthermore, with reference to FIG. 7, a description will be given hereinbelow of a method, in which a mobile router offers a prefix for a stateless address configuration to an unauthenticated local node, according to a third embodiment of the present invention. FIG. 7 is a flow chart showing one example of a method, in which a mobile router provides a prefix for a stateless address configuration to an unauthenticated local node, according to the third embodiment of the present invention.

At a step S70, the MR 10 makes a verification on the authenticity of an LN 20b (whether or not the LN 20b is an authenticated node). In a case in which the LN 20b can implement the authentication processing with respect to the MR 10, at a step S71, the MR 10 acknowledges that the LN 20b is a local node. On the other hand, the third embodiment of the present invention is on the assumption that the LN 20b does not have a function to implement the authentication processing with respect to the MR 10. In this case, at a step S72, the MR 10 handles the LN 20b as a visitor node within the mobile PAN 31. For example, 802.1x is known as an authentication discipline, but the authentication discipline is not limited to this.

In the following processing, there is conducted the prefix delegation processing at the steps S60 to S63 described above with reference to FIG. 6. The details of this processing are the same as those described above, and the description thereof will be omitted.

As described above, according to the third embodiment of the present invention, the MR 10 can handle, as a visitor node or visitor router, a node or router within the mobile PAN 31 which cannot implement the authentication processing, and can carry out the prefix delegation. Therefore, the MR 10 handles the unacknowledged node or router as a visitor node or visitor router, and permits only the use of the address using the MNP_{AR} with respect to this node or router. Thus, the MR 10 can manage the delegation of MNP_{NEMO}, thereby preventing an unauthenticated node from behaving as a local node capable of gaining access to the user's network and reducing the risk of a rogue node impersonating a local node, so the security with a given level is realizable within the mobile PAN 31.

In the third embodiment of the present invention, a person skilled in the art would appreciate that it is also acceptable that a plurality of unauthenticated routers or nodes exist within the mobile PAN 31.

### FOURTH EMBODIMENT

Furthermore, a description will be given hereinbelow of a method of carrying out a stateful address configuration according to a fourth embodiment of the present invention. In the description of the fourth embodiment of the present invention, the MR 10 functions as a DHCP server and a router advertisement is not transmitted into the mobile PAN 31 (or, a prefix for an address configuration is not inserted into a router advertisement.

In the fourth embodiment of the present invention, the VN 20a starts the stateful address configuration processing, for example, in the case of no detection of an RA. In this case, the VN 20a transmits a multicast DHCP solicitation message for finding an available DHCP server.

Upon receipt of this DHCP solicitation message, the MR 10 makes a response through the use of a DHCP advertisement message. Moreover, the VN 20a transmits a DHCP address request message, as a response to a DHCP advertisement message by the MR 10, to the MR 10 for requesting reliable address allocation and other configuration information. The MR 10 makes a response to the VN 20a through the use of a DHCP address response message including a verified address (non-duplicate address) and configuration information. At this time, since the MR 10 accomplishes the address allocation by utilizing the DHCP, it is possible to selectively offer prefixes to be used by a visitor node or a local node.

In a normal case, a request node (source of a DHCP address request message) enables a DHCP node to identify this node through the DHCP. By utilizing this, the MR 10 can make an identification as to whether the request node is a visitor node or a local node so as to allocate an address having an appropriate prefix. Incidentally, it is preferable that the DHCP request contains information whereby the MR 10 can identify the identity of the request node.

Moreover, in a case in which the MR 10 cannot sufficiently identify a request node, when the information needed for an MR to identify a request node is not included in a DHCP request, or in other cases, it is also appropriate that the MR 10 merely handles a request node as a visitor node and allocates an address derived from the MNP_{AR}.

As described above, according to the fourth embodiment of the present invention, in a case in which a stateful address allocation is made to a node within the mobile PAN 31, it is possible to correctly select an address (address including the MNP_{AR} or address including the MNP_{NEMO}) to be allocated to this node in accordance with a result of the node identification by the DHCP server.

In the fourth embodiment of the present invention, a person skilled in the art would appreciate that it is also acceptable that a plurality of routers or nodes exist within the mobile PAN 31.

### FIFTH EMBODIMENT

Furthermore, a description will be given hereinbelow of a fifth embodiment of the present invention. The fifth embodiment of the present invention will be described about a method of carrying out a stateless address configuration with respect to a legacy node which is made to conduct a duplicate address detection on only its interface address (interface identifier).

A legacy node using a stateless address auto-configuration carries out a duplicate address detection (DAD) on a unicast address prior to allocating the unicast address to an interface, and there is a need to conduct a test as to whether or not the unicast address has the uniqueness.

However, in the case of the employment of the stateless address auto-configuration, the uniqueness of an address is judged on the basis of only an interface identifier, assuming that a prefix of a subnet is allocated correctly. For this reason, a problem will arise in a case in which a legacy node or legacy router which cannot understand the prefix choice 43a in the RA 40 selects a mistaken MNP and generates its own global address.

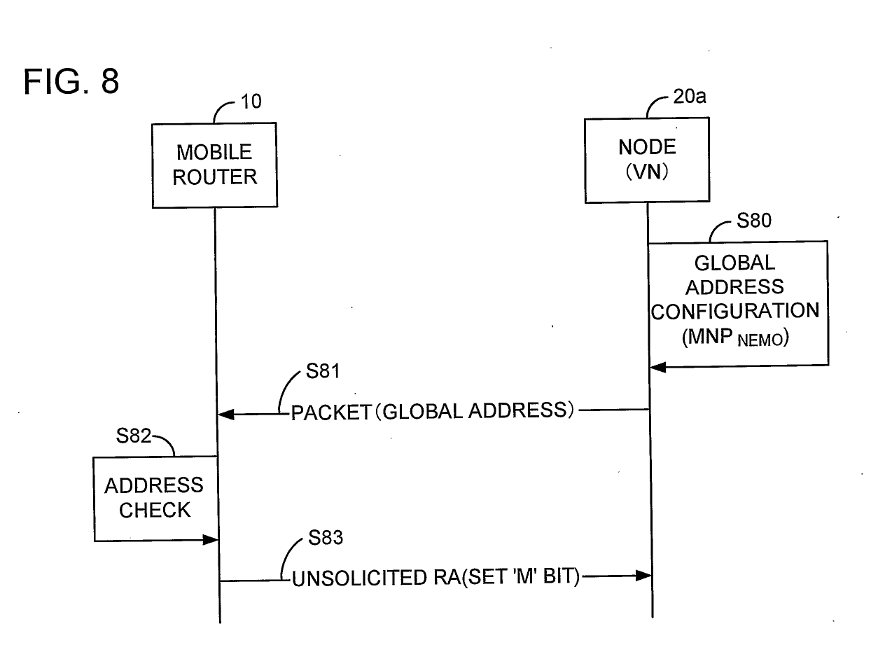

With reference to FIG. 8, a description will be given hereinbelow of a method of offering a prefix to a legacy node which is made to carry out a duplicate address detection on only its own interface address (interface identifier) according to a fifth embodiment of the present invention. FIG. 8 is a sequence chart showing one example of a method of offering a prefix to a legacy node which is made to carry out a duplicate address detection on only its own interface address (interface identifier) according to a fifth embodiment of the present invention. In the following description of the fifth embodiment of the present invention, let it be assumed that a VN 20a shown in FIG. 8 is a legacy node and it implements a stateless address auto-configuration.

Upon entering a network, the VN 20a is authenticated by the MR 10 through the use of an authentication technique (not limited to this) such as 802.1x. Moreover, the VN 20a carries out the duplicate address detection (DAD) on the interface identifier so as to test the uniqueness of the tentative address.

When the test on the uniqueness of the interface identifier reaches completion, at a step S80, for example, the VN 20a extracts a usable prefix (MNP_{NEMO} 43a) existing at the head of the option 43 of the RA 40 so as to combine it with its own interface identifier, thus configuring its own global address.

In addition, the VN 20a starts a packet communication using this global address and, at a step S81, it makes a packet transmission where this global address is set as a source address. At this time, at a step S82, the MR 10 checks the global address of the VN 20a set as the source address on this packet so as to confirm whether or not a correct MNP is in use.

In this case, since the MNP_{NEMO} is used for the global address of the VN 20a, the MR 10 makes a judgment that the VN 20a is using an incorrect MNP and, at a step S83, it transmits, to the VN 20a, an unsolicited RA) where a “managed address configuration flag” (equally referred to as M bit) is set. The setting of the M bit is for notifying the implementation of the stateful address configuration. Moreover, the “unsolicited” signifies that a transmission is made without receiver's approval.

Upon receipt of an unsolicited RA transmitted at the step S83, the VN 20a conducts an address configuration through the use of a stateful protocol. In this case, for example, the address configuration stateful protocol carries out the above-mentioned processing based on the DHCP, which has described in the fourth embodiment of the present invention.

Ad described above, according to the fifth embodiment of the present invention, it is possible to allocate an address including a correct MNP to a legacy node or legacy router which merely carries out the duplicate address detection on only its own interface identifier.

In the fifth embodiment of the present invention, a person skilled in the art would appreciate that it is also acceptable that a plurality of legacy routers or legacy nodes exist in the mobile PAN 31.

### SIXTH EMBODIMENT

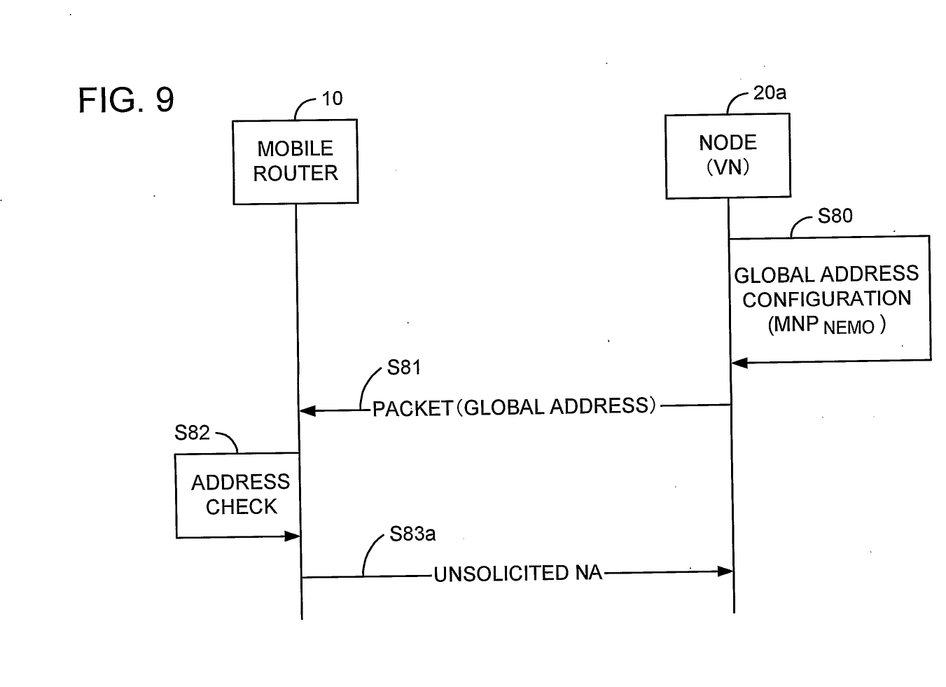

Furthermore, with reference to FIG. 9, a description will be given hereinbelow of a method of offering a prefix for a stateless address configuration to a legacy node which is made to carry out a duplicate address detection on only its own interface address (interface identifier) according to a sixth embodiment of the present invention. FIG. 9 is a sequence chart showing one example of a method of carrying out a stateless address configuration with respect to a legacy node which is made to carry out a duplicate address detection on only its own interface address (interface identifier) according to a sixth embodiment of the present invention. In the following description of the sixth embodiment of the present invention, let it be assumed that a VN 20a shown in FIG. 9 is a legacy node and it conducts a stateless address auto-configuration.

Upon entering a network, the VN 20a is authenticated by the MR 10 through the use of an authentication technique (not limited to this) such as 802.1x. Moreover, the VN 20a carries out a duplicate address detection (DAD) on the interface identifier, thereby testing the uniqueness of a tentative address.

When the test on the uniqueness of the interface identifier reaches completion, at a step S80, for example, the VN 20a configures its own global address by using a usable prefix (MNP_{NEMO} 43a) existing at the head of the option 43 of the RA 40 and, at a step S81, makes a packet transmission where this global address is set as a source address. Meanwhile, at a step S82, the MR 10 checks whether or not the VN 20a is using a correct MNP. The above-mentioned steps S80 to S82 are the same as those shown in FIG. 8, and the detailed description will be omitted here.

In this case, since the MNP_{NEMO} is used for the global address of the VN 20a, the MR 10 makes a judgment that the VN 20a is using an incorrect MNP and, at a step S83a, the MR 10 transmits an unsolicited NA to the VN 20a. This unsolicited NA is indicative of the address duplication.

Upon receipt of the unsolicited NA transmitted at the step S83a, the VN 20a makes a judgment that it own global address is not unique and, after the stand-by (back-off) for a random period of time, it re-conducts the address auto-configuration.

Also in this case, as well as the second embodiment of the present invention, if the number of times of failure of the DAD processing on the tentative address including a specified MNP (i.e., MNP_{NEMO}) reaches a predetermined value, the VN 20a employs a different MNP (i.e., MNP_{AR}) in the RA 40, thus configuring an address including an appropriate prefix (MNP_{AR}).

As described above, according to the sixth embodiment of the present invention, a new address configuration becomes feasible by transmitting an unsolicited NA indicative of the address duplication to a legacy node or legacy router which is made to merely carry out a duplicate address detection on only its own interface identifier. In a case in which the legacy node or legacy router selects a different correct MNP (MNP_{AR}), it is possible to configure a valid address usable within the mobile PAN 31.

In the sixth embodiment of the present invention, a person skilled in the art would appreciate that it is also acceptable that a plurality of legacy routers or legacy nodes exist in the mobile PAN 31.

### SEVENTH EMBODIMENT

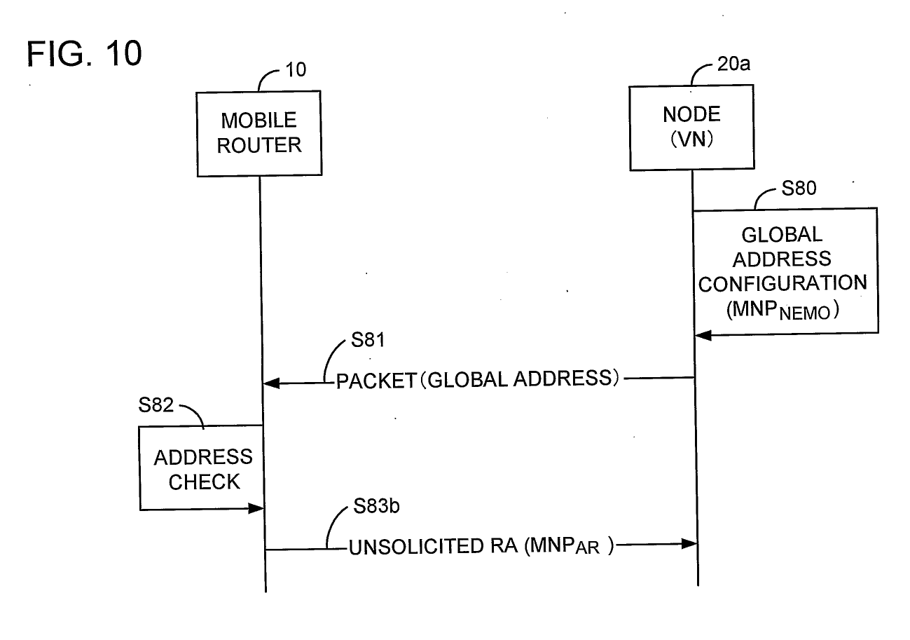

Moreover, with reference to FIG. 10, a description will be given hereinbelow of a method of offering a prefix for a stateless address configuration to a legacy node which is made to carry out a duplicate address detection on only its own interface address (interface identifier) according to a seventh embodiment of the present invention. FIG. 10 is a sequence chart showing one example of a method of offering a prefix for a stateless address configuration with respect to a legacy node which is made to carry out a duplicate address detection on only its own interface address (interface identifier) according to a seventh embodiment of the present invention. In the following description of the seventh embodiment of the present invention, let it be assumed that a VN 20a shown in FIG. 10 is a legacy node and it conducts a stateless address auto-configuration.

Upon entering a network, the VN 20a is authenticated by the MR 10 through the use of an authentication technique (not limited to this) such as 802.1x. Moreover, the VN 20a carries out a duplicate address detection (DAD) on the interface identifier, thereby testing the uniqueness of a tentative address.

When the test on the uniqueness of the interface identifier reaches completion, at a step S80, for example, the VN 20a configures its own global address by using a usable prefix (MNP_{NEMO} 43a) existing at the head of the option 43 of the RA 40 and, at a step S81, makes a packet transmission where this global address is set as a source address. Meanwhile, at a step S82, the MR 10 checks whether or not the VN 20a is using a correct MNP. The above-mentioned steps S80 to S82 are the same as those shown in FIG. 8, and the detailed description will be omitted here.

In this case, since the MNP_{NEMO} is used for the global address of the VN 20a, the MR 10 makes a judgment that the VN 20a is using an incorrect MNP and, at a step S83b, the MR 10 transmits an unsolicited RA including only the MNP_{AR} in the option 43 to the VN 20a. Upon receipt of the unsolicited RA transmitted at the step S83b, the VN 20a configures a new global address by using the MNP_{AR} advertised at the step S83b, thereby generating address using a correct prefix (MNP_{AR}). In this case, it is preferable that the unsolicited RA is transmitted through the unicast to the VN 20a.

As described above, according to the seventh embodiment of the present invention, a correct re-configuration of a new address becomes feasible by transmitting an unsolicited RA including a correct prefix to a legacy node or legacy router which is made to merely carry out a duplicate address detection on only its own interface identifier.

In this connection, there is a case in which the VN 20a which has received the unsolicited RA transmitted at the step S83b cannot grasp that this unsolicited RA is a request for the address re-configuration using the MNP_{AR}. Thus, it is also appropriate that, in consideration of such a case, the sixth and seventh embodiments of the present invention are combined with each other so as to transmit the unsolicited RA (the step S83b in FIG. 10) including only the MNP_{AR} immediately after the transmission of the unsolicited NA (the step S83b in FIG. 9) indicative of the address duplication.

In the seventh embodiment of the present invention, a person skilled in the art would appreciate that it is also acceptable that a plurality of legacy routers or legacy nodes exist in the mobile PAN 31.

### EIGHTH EMBODIMENT

Furthermore, a description will be given hereinbelow of an eighth embodiment of the present invention. Although in the above-described first to seventh embodiments of the present invention the offer of a correct prefix (or address using a correct prefix) is principally realized by an MR, it is also appropriate that the offer of a prefix is made by an AR 10a directly connected to one or a plurality of routers or nodes.

In the eighth embodiment of the present invention, the AR 10a is made to advertise one or a plurality of MNPs to a router or node directly connected to the AR 10a. In this case, the respective components of the AR 10a are the same as those of the MR 10 shown in FIG. 1. However, it is preferable that the MNP_{NEMO} is interpreted as a prefix for specifying an access network under the AR 10a, which is originally advertised by the AR 10a, while the MNP_{AR} is interpreted as a prefix for specifying a host network with which the AR 10a makes a direct or indirect connection.

### NINTH EMBODIMENT

The techniques of enforcing the usage of correct prefix described hereinabove are all based on a mobile network scenario. However, a person skilled in the relevant art would appreciate that the techniques as described can be applied to other scenarios, not necessarily limited to a mobile network. The ninth embodiment of the present invention describes one example.

Consider the case of a Mobile IPv6 node and its home agent. For reasons such as to enable flow filtering or otherwise, a mobile IPv6 node may not want to use its home address even when it is at its home link. This is because when a mobile node uses its home address when it is attached to its home link, it has to remove the binding registered at the home agent. This may cause the mobile node to loose services provided by a home agent due to the deregistration. In order to allow a mobile IPv6 node not to use its home address when it is attached to its home link, the home agent can advertise two or more prefixes. The first prefix is the normal home prefix. The home address of the mobile node is configured from this home prefix. The other prefix (or prefixes) may be known as a home-foreign prefix. This home-foreign prefix is used by the mobile node to configure a care-of address so that it need not use its home address when attached to the home link. With this care-of address configured from the home-foreign prefix, the mobile node can continue to send binding registration (which binds the home address of the mobile node to the care-of address) to the home agent, thereby continuing to enjoy services provided by the home agent that are not available when the such binding registration is removed. One example of such services is flow filtering at the home agent.

With two prefixes announced on the home link, other nodes attached to the home link may (mistakenly) use either prefixes to configure their addresses. This may cause unnecessary DAD traffic in the home link, or the use of addresses configured from the home-foreign prefix by other nodes may be prohibited by policy (due to billing and accounting reasons, etc). To resolve this problem, the home agent may use the methods as described in the first to eight embodiments of the present invention to ensure that only valid mobile nodes can configure an address from the home-foreign prefix. Other nodes (such as local nodes or legacy mobile nodes) attached to the home link will continue to use the home prefix to configure their addresses.

As described in previous embodiments, the home agent may include the two prefixes in a single RA and include prefix choice information (as a separate option, a flag, or simply the order of the prefixes' appearance in the RA), or send the prefixes separately in distinct RA messages. The mobile node would need to implement VN functionalities as described previously to correctly recognize the home-foreign prefix and use the home-foreign prefix when it chooses to retain its binding registration with the home agent. The home agent may use the technique of responding with NA messages to NS messages when the home agent detects that these NS messages are a result of nodes trying to perform DAD on addresses configured from a wrong prefix.

Thus effectively, with the present invention employed in the above scenario, the home agent can ensure that local nodes or legacy mobile nodes will only configure their addresses from the home prefix. Mobile nodes which do not want to use their home addresses (so as to continue enjoying services provided by the home agent by maintaining a binding registration at the home agent) can configure their care-of addresses from the home-foreign prefix. The home agent can verify if the mobile node is entitled to use the home-foreign prefix and admit or reject the address configuration appropriately using mechanisms as described in this description.

The technical contents disclosed in the above-described embodiments of the present invention only express one mode of the present invention, and the present invention covers the scope understood and inferred from the technical contents disclosed in the above-described embodiments. Moreover, the meanings of terms used in the above-described embodiments of the present invention, the definitions of the terms and others are not limited to the embodiments, and they are applicable to other embodiments. Still moreover, the present invention is also realizable by combining the above-described respective embodiments of the present invention in an arbitrary manner.

In addition, although in this description a mobile PAN is taken as one example of a mobile network, the present invention is not limited to the case in which the mode of a mobile network is a mobile network. Moreover, in addition to a case in which the mobile router in the present invention is a terminal device having an individual substance, the present invention is also applicable to a logical presence, in which software or the like is packaged, which moves as a logical entity between fixed stations forming actual connection points of a mobile terminal and offers a mobile network to the mobile terminal.

Still additionally, the respective functional blocks used in the above description of the embodiments of the present invention are typically realized with an LSI (Large Scale Integration) which is an integrated circuit. It is also acceptable that these blocks are individually formed as one chip, or that a portion of or all of these blocks are formed as one chip. Although an LSI is taken in this case, it is sometimes referred to as an IC (Integrated Circuit), system LSI, super LSI or ultra LSI according to the level of integration.

Moreover, the technique for the formation of an integrated circuit is not limited to the LSI, but it is also realizable with a dedicated circuit or a general-purpose processor. After the manufacturing of an LSI, it is also acceptable to utilize an FPGA (Field Programmable Gate Array) which enables the programming or a reconfigurable processor which allows the reconfiguration of connections and setting of circuit cells in the interior of the LSI.

Still moreover, if a technique for the formation of an integrated circuit replaceable with the LSI appears owing to advance in semiconductor technology or a different technology derived therefrom, the functional blocks can naturally be integrated through the use of this technique. For example, a biotechnology or the like may be applicable.

### INDUSTRIAL APPLICABILITY

The present invention provides an advantage in that a communication node connected to a router which advertise a plurality of prefixes can use an address including an appropriate prefix, particularly, provides an advantage in that, when a communication node is connected to a mobile PAN having a mobile router which advertises a plurality of prefixes, the communication node can use an address including an appropriate prefix. The present invention is applicable to a technique related to a prefix advertisement in a network (particularly, a mobile network) and a network technique using radio communication.

1. An apparatus for prefix control, which is connected to a first network specified by a first prefix and which operates in a router having, as a subordinate, a second network specified by a second prefix, comprising:
prefix advertising means for advertising the first and second prefixes to said second network; and
prefix control means for allowing a communication node connected to said second network to use an address configured by the first or second prefix appropriate to the communication node.

2. The apparatus for prefix control according to claim 1, further comprising message generating means for generating, as a message for advertising the first and second prefixes, a message including the first and second prefixes and prefix choice information indicative of one of the first and second prefixes to be selected on the basis of a function of said communication node connected to said second network.

3. The apparatus for prefix control according to claim 1, wherein the first prefix is set at an appropriate prefix with respect to a communication node belonging to a home network different from a home network to which said router belongs, while the second prefix is set at an appropriate prefix with respect to a communication node belonging to the home network which is the home network to which said router belongs.

4. The apparatus for prefix control according to claim 1, further comprising:
duplicate address detection message receiving means for receiving, from the communication node connected to said second network, a duplicate address detection message on an address of the communication node;
prefix judging means for making a judgment as to whether or not the address included in the message received by said duplicate address detection message receiving means is configured by using a prefixed appropriate to the communication node; and
response means for, when the judgment in said prefix judging means shows that the address is not configured by using the appropriate prefix, transmitting a message indicative of the fact that the address is in a duplicate state.

5. The apparatus for prefix control according to claim 1, further comprising:
authentication means for carrying out authentication processing on the communication node connected to said second network; and
prefix appropriateness setting means for, with respect to a communication node which is not authenticated by said authentication means, setting the first prefix at a prefix appropriate to the communication node.

6. The apparatus for prefix control according to claim 1, further comprising:
communication node identifying means for identifying the communication node connected to said second network as to whether or not the communication node belongs to the home network which is the home network to which said router belongs; and
address offering means for, on the basis of a result of the identification by said communication node identifying means, offering an address including the first prefix to a communication node belonging to a home network different from the home network to which said router belongs and offering an address including the second prefix to a communication node belonging to the home network which is the home network to which said router belongs.

7. The apparatus for prefix control according to claim 1, further comprising:
packet receiving means for receiving, from the communication node connected to said second network, a packet in which an address configured by the communication node itself is set as a source address;
prefix judging means for making a judgment as to whether or not the address of the communication node set as the source address in the packet received by said packet receiving means is configured by using a prefix appropriate to the communication node; and
address offering means for, when the judgment in said prefix judging means shows that the address is not configured by using the appropriate prefix, offering an address including the appropriate prefix.

8. The apparatus for prefix control according to claim 1, further comprising:
packet receiving means for receiving, from the communication node connected to said second network, a packet in which an address configured by the communication node itself is set as a source address;
prefix judging means for making a judgment as to whether or not the address of the communication node set as the source address in the packet received by the packet receiving means is configured by using a prefix appropriate to the communication node; and
response means for, when the judgment in the prefix judging means shows that the address is not configured by using the appropriate prefix, transmitting a message indicative of the fact that the address is in a duplicate state.

9. The apparatus for prefix control according to claim 1, further comprising:
packet receiving means for receiving, from the communication node connected to said second network, a packet in which an address configured by the communication node itself is set as a source address;
prefix judging means for making a judgment as to whether or not the address of the communication node set as the source address in the packet received by said packet receiving means is configured by using a prefix appropriate to the communication node; and
appropriate prefix advertising means for, when the judgment in said prefix judging means shows that the address is not configured by using an inappropriate prefix, advertising a prefix, appropriate to the communication node, to the communication node.

10. The apparatus for prefix control according to claim 1, wherein said router is a movable mobile router or an access router fixed to a network.

11. An apparatus for prefix choice, which operates in a communication node connectable to a network, comprising:
message receiving means for receiving, from a router connected to a first network specified by a first prefix and having, as a subordinate, a second network specified by a second prefix, a message including the first and second prefixes and prefix choice information indicative of one of the first and second prefixes to be selected on the basis of a function of a communication node connected to said second network; and
prefix choosing means for, on the basis of the prefix choice information included in the message received by said message receiving means, choosing the first or second prefix appropriate to the communication node, which is to be used for a configuration of an address of the communication node.

12. The apparatus for prefix choice according to claim 11, wherein, in a case in which the communication node belongs to a home network different from a home network to which said router belongs, the communication node chooses the first prefix as an appropriate prefix while, when the communication node belongs to the home network which is the home network to which said router belongs, the communication node chooses the second prefix as an appropriate prefix.
